(19) United States
(12) Patent Application Publication
(10) Pub. No.: US 2012/0304399 A1
(43) Pub. Date: Dec. 6, 2012

(54) SURFACTANT RATIO IN DYE FORMULATIONS

(76) Inventors: Stephen Norman Batchelor, Bebington (GB); Jayne Michelle Bird, Bebington (GB)

(21) Appl. No.: 13/519,342

(22) PCT Filed: Aug. 12, 2010
(86) PCT No.: PCT/EP2010/061758

§ 371 Date: Aug. 13, 2012

(30) Foreign Application Priority Data
Jan. 6, 2010 (EP) 10150161.7

(51) Int. Cl. C11D 3/42; D06L 1/16; C11D 9/26

(52) U.S. Cl. 8/137; 510/324

(57) ABSTRACT

The present invention provides shading formulation of enhanced effectiveness by using different types of surfactants in specific ratios.

### FIELD OF INVENTION

The present invention concerns laundry shading dye compositions.

### BACKGROUND OF THE INVENTION

Anionic surfactants are widely used in main wash detergents. To increase the cleaning ability of formulations non-ionic surfactants are added.

WO2006/045375 (Unilever), U.S. Pat. No. 7,208,459 (Procter and Gamble) and WO2008/087497 (Procter and Gamble) disclose the use of uncharged blue or violet dyes with alkoxy chains in detergent formulations. The alkoxylated dyes deposit to fabrics and enhance garment whiteness.

It is desirable to have higher whiteness to synthetic garments.

### SUMMARY OF THE INVENTION

The present invention provides shading formulation that provides a greater whiteness benefit to synthetic garments, particularly nylon and elastane.

In one aspect the present invention provides a laundry detergent formulation comprising:
(i) from 0.0001 to 0.01 wt % of a blue or violet uncharged alkoxylated dye; and,
(ii) from 2 to 70 wt % of surfactant selected from anionic and non-ionic surfactants, wherein the weight ratio of anionic:non-ionic surfactant is from 50:50 to 0:100, preferably, 40:60 to 0:100, more preferably, from 25:75 to 0:100.

In another aspect the present invention provides a domestic method of treating a laundry textile, the method comprising the steps of:
(i) treating a textile with an aqueous solution of the 1 to 10 g/L of the formulation;
(ii) optionally rinsing; and,
(iii) drying the textile.

### DETAILED DESCRIPTION OF THE INVENTION

Alkoxylated Dyes

The alkoxylated dye is blue or violet. Preferably the blue or violet alkoxylated dye gives a blue or violet colour to the cloth with a hue angle of 250 to 345, more preferably 265 to 330, most preferably 270 to 300. The cloth used to determine the hue angle is white bleached non-mercerised woven cotton sheeting.

The dye has a molar extinction coefficient at a wavelength in the range 400 to 700 nm of at least 1000 mol⁻¹ L cm⁻¹, preferably greater than 6000 mol⁻¹ L cm⁻¹.

The alkoxylated dyes of are of the following generic form: Dye-NR₁R₂. The NR₁R₂ group is attached to an aromatic ring of the dye. R₁ and R₂ are independently selected from polyoxyalkylene chains having 2 or more repeating units and preferably having 2 to 20 repeating units. Examples of polyoxyalkylene chains include ethylene oxide, propylene oxide, glycidol oxide, butylene oxide and mixtures thereof.

The alkoxylated dye is uncharged in contrast to anionic and cationic dyes; the alkoxylated dye per se is neutral in an aqueous medium at pH 7. The alkoxylated dye does not have sulphonate nor carboxylate groups nor cationic groups.

A preferred polyoxyalkylene chain is [(CH₂CR₃HO)ₓ(CH₂CR₄HO)_{y}R₅) in which x+y≦5 wherein y≧1 and z=0 to 5, R₃ is selected from: H; CH₃; CH₂O(CH₂CH₂O)_{z}H and mixtures thereof; R₄ is selected from: H; CH₂O(CH₂CH₂O)_{z}H and mixtures thereof; and, R₅ is selected from: H; and, CH₃

Preferably the dye is an anthraquinone or an azo dye.

Preferably the alkoxylated dye is a mono-azo dye.

Preferably the alkoxylated dye is of the structure:

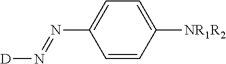

D denotes an aromatic or hetroaromatic group. Preferably D is selected from the group consisting of: azothiophenes, azobenzothiazoles and azopyridones. The aromatic rings may be further substituted. Most preferably the dye is an azo thiophene.

Most preferably the dye is selected from

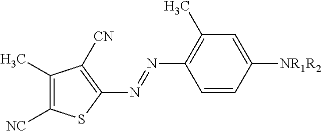

Surfactant

The composition comprises between 2 to 70 wt % of a surfactant, most preferably 10 to 30 wt %. In general, the nonionic and anionic surfactants of the surfactant system may be chosen from the surfactants described “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981. Preferably the surfactants used are saturated.

1) Anionic Surfactants

Suitable anionic detergent compounds which may be used are usually water-soluble alkali metal salts of organic sulphates and sulphonates having alkyl radicals containing from about 8 to about 22 carbon atoms, the term alkyl being used to include the alkyl portion of higher acyl radicals.

Examples of suitable synthetic anionic detergent compounds are sodium and potassium alkyl sulphates, especially those obtained by sulphating higher C₈ to C₁₈ alcohols, produced for example from tallow or coconut oil, sodium and potassium alkyl C₉ to C₂₀ benzene sulphonates, particularly sodium linear secondary alkyl C₁₀ to C₁₅ benzene sulphonates; and sodium alkyl glyceryl ether sulphates, especially those ethers of the higher alcohols derived from tallow or coconut oil and synthetic alcohols derived from petroleum. Most preferred anionic surfactants are sodium lauryl ether sulfate (SLES), particularly preferred with 1 to 3 ethoxy groups, sodium C₁₀ to C₁₅ alkyl benzene sulphonates and sodium C₁₂ to C₁₈ alkyl sulphates. Also applicable are surfactants such as those described in EP-A-328 177 (Unilever), which show resistance to salting-out, the alkyl polyglycoside surfactants described in EP-A-070 074, and alkyl monoglycosides. The chains of the surfactants may be branched or linear.

Soaps are also preferred. The fatty acid soap used preferably contains from about 16 to about 22 carbon atoms, preferably in a straight chain configuration. The anionic contribution from soap is preferably from 0 to 30 wt % of the total anionic.

Preferably, at least 50 wt % of the anionic surfactant are selected from: sodium C₁₁ to C₁₅ alkyl benzene sulphonates; and, sodium C₁₂ to C₁₈ alkyl sulphates. Even more preferably, the anionic surfactant is sodium C₁₁ to C₁₅ alkyl benzene sulphonates. 2) Non-Ionic Surfactants

Suitable nonionic detergent compounds which may be used include, in particular, the reaction products of compounds having a hydrophobic group and a reactive hydrogen atom, for example, aliphatic alcohols, acids, amides or alkyl phenols with alkylene oxides, especially ethylene oxide either alone or with propylene oxide. Preferred nonionic detergent compounds are C₆ to C₂₂ alkyl phenol-ethylene oxide condensates, generally 5 to 25 EO, i.e. 5 to 25 units of ethylene oxide per molecule, and the condensation products of aliphatic C₈ to C₁₈ primary or secondary linear or branched alcohols with ethylene oxide, generally 5 to 40 EO. Alkyl ethoxylates are particularly preferred.

Builder

The formulation may contain a builder.

Builder materials may be selected from 1) calcium sequestrant materials, 2) precipitating materials, 3) calcium ion-exchange materials and 4) mixtures thereof.

Examples of calcium sequestrant builder materials include alkali metal polyphosphates, such as sodium tripolyphosphate and organic sequestrants, such as ethylene diamine tetra-acetic acid.

Examples of precipitating builder materials include sodium orthophosphate and sodium carbonate. Preferably, the laundry treatment composition comprises sodium carbonate in the range from 5 to 50 wt %, most preferably 10 to 35 wt %. In the method, when used with granular laundry treatment composition, the aqueous wash solution preferably comprises 0.1 to 4 g/L of sodium carbonate.

Examples of calcium ion-exchange builder materials include the various types of water-insoluble crystalline or amorphous aluminosilicates, of which zeolites are the best known representatives, e.g. zeolite A, zeolite B (also known as zeolite P), zeolite C, zeolite X, zeolite Y and also the zeolite P-type as described in EP-A-0,384,070.

The composition may also contain 0-65% of a builder or complexing agent such as ethylenediaminetetraacetic acid, diethylenetriamine-pentaacetic acid, alkyl- or alkenylsuccinic acid, nitrilotriacetic acid or the other builders mentioned below. Many builders are also bleach-stabilising agents by virtue of their ability to complex metal ions.

Zeolite and carbonate (carbonate (including bicarbonate and sesquicarbonate) are preferred builders.

The composition may contain as builder a crystalline aluminosilicate, preferably an alkali metal aluminosilicate, more preferably a sodium aluminosilicate. This is typically present at a level of less than 15% w. Aluminosilicates are materials having the general formula:
0.8-1.5 M₂O. Al₂O₃. 0.8-6 SiO₂
   where M is a monovalent cation, preferably sodium. These materials contain some bound water and are required to have a calcium ion exchange capacity of at least 50 mg CaO/g. The preferred sodium aluminosilicates contain 1.5-3.5 SiO₂ units in the formula above. They can be prepared readily by reaction between sodium silicate and sodium aluminate, as amply described in the literature. The ratio of surfactants to alumuminosilicate (where present) is preferably greater than 5:2, more preferably greater than 3:1.

Alternatively, or additionally to the aluminosilicate builders, phosphate builders may be used. In this art the term ‘phosphate’ embraces diphosphate, triphosphate, and phosphonate species. Other forms of builder include silicates, such as soluble silicates, metasilicates, layered silicates (e.g. SKS-6 from Hoechst).

Preferably the laundry detergent formulation is a non-phosphate built laundry detergent formulation, i.e., contains less than 1 wt % of phosphate.

Enzymes

The composition may comprise one or more enzymes, which provide cleaning performance, fabric care and/or sanitation benefits.

Especially contemplated enzymes include proteases, alpha-amylases, cellulases, lipases, peroxidases/oxidases, pectases, lyases, and mannanases, or mixtures thereof.

Most suitable lipases are disclosed in WO 2007/087257, WO2009/107091 and WO2009/111258.

Fluorescent Agent

The composition preferably comprises a fluorescent agent (optical brightener). Fluorescent agents are well known and many such fluorescent agents are available commercially. Usually, these fluorescent agents are supplied and used in the form of their alkali metal salts, for example, the sodium salts. The total amount of the fluorescent agent or agents used in the composition is generally from 0.005 to 2 wt %, more preferably 0.01 to 0.1 wt %. Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra and Blankophor (Trade Mark) HRH, and Pyrazoline compounds, e.g. Blankophor SN. Preferred fluorescers are: sodium 2 (4-styryl-3- sulfophenyl)-2H-napthol[1,2-d]triazole, disodium 4,4′- bis{[(4-anilino-6-(N methyl-N-2 hydroxyethyl) amino 1,3,5- triazin-2-yl)]amino}stilbene-2-2′ disulfonate, disodium 4,4′-bis{[(4-anilino-6-morpholino-1,3,5-triazin-2-yl)]amino}stilbene-2-2′ disulfonate, and disodium 4,4′-bis(2-sulfostyryl)biphenyl.

Perfume

Preferably the composition comprises a perfume. The perfume is preferably in the range from 0.001 to 3 wt %, most preferably 0.1 to 1 wt %. Many suitable examples of perfumes are provided in the CTFA (Cosmetic, Toiletry and Fragrance Association) 1992 International Buyers Guide, published by CFTA Publications and OPD 1993 Chemicals Buyers Directory 80th Annual Edition, published by Schnell Publishing Co.

It is commonplace for a plurality of perfume components to be present in a formulation. In the compositions of the present invention it is envisaged that there will be four or more, preferably five or more, more preferably six or more or even seven or more different perfume components.

In perfume mixtures preferably 15 to 25 wt % are top notes. Top notes are defined by Poucher (Journal of the Society of Cosmetic Chemists 6(2):80 [1955]). Preferred top-notes are selected from citrus oils, linalool, linalyl acetate, lavender, dihydromyrcenol, rose oxide and cis-3-hexanol.

Perfume and top note may be used to cue the whiteness benefit of the invention.

Experimental

Woven cotton fabric, knitted nylon-elastane (80:20) and knitted microfiber polyester fabric were washed in an aqueous wash solution (demineralised water) containing 1 g/L surfactant, 1 g/L sodium carbonate and 1 g/L sodium chloride at a liquor to cloth ratio of 30:1. The surfactant system was chosen from various ratio's of Linear Alkyl benzene sulfonate (LAS): NI(7EO) which is R-(OCH₂CH₂)ₙOH, where R is an alkyl chain of C12 to C15, and n is 7. To the wash solution an alkoxylated shading dye was added such that the wash solution contained nominally 0.5 ppm of the dye. The alkoxylated shading dye used was:

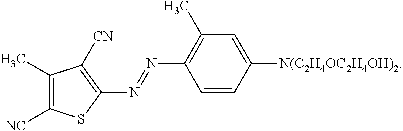

After 30 minutes of agitation the cloths were removed rinsed and dried. Washes were then repeated until 4 wash cycles had been accomplished. After the 4^{th} wash the reflectance spectra of the cloth were measured on a reflectometer and the colour expressed as CIE L*a*b* values.

The increased in whiteness of the cloth was expressed as the change in blue:
Δb=b_{before wash}^{-b}_{after wash}.

The results are given in the table below

| | Δb | | |
|---|---|---|---|
| | Nylon- | | |
| LAS:NI | elastane | polyester | cotton |
| 0:100 | 6.9 | 2.3 | 3.2 |
| 25:75 | 5.9 | 2.0 | 2.8 |
| 50:50 | 4.9 | 1.9 | 3.0 |
| 75:25 | 4.3 | 1.9 | 2.9 |
| 100:0 | 3.5 | 1.8 | 3.0 |

The dye deposits from all surfactant systems. There is higher deposition to the synthetic fabrics from the surfactant systems with higher levels of anionic surfactants.

1. A laundry detergent formulation comprising:
(i) from 0.0001 to 0.01 wt % of a blue or violet uncharged alkoxylated dye; and,
(ii) from 2 to 70 wt % of surfactant selected from anionic and non-ionic surfactants, wherein the weight ratio of anionic:non-ionic surfactant is from 50:50 to 0:100.

2. A laundry detergent formulation according to claim 1, wherein the weight ratio of anionic:non-ionic surfactant is from 40:60 to 0:100.

3. A laundry detergent formulation according to claim 2, wherein the weight ratio of anionic:non-ionic surfactant is from 25:75 to 0:100.

4. A laundry detergent formulation as defined in claim 1, wherein the anionic surfactants are selected from: sodium lauryl ether sulfate (SLES) with 1 to 3 ethoxy groups; sodium C₁₁ to C₁₅ alkyl benzene sulphonates; sodium C₁₂ to C₁₈ alkyl sulphates; and, soap.

5. A laundry detergent formulation as defined in claim 1, wherein at least 50 wt % of the anionic surfactant are selected from: sodium C₁₀ to C₁₅ alkyl benzene sulphonates; and, sodium C₁₂ to C₁₈ alkyl sulphates.

6. A laundry detergent formulation as defined in claim 1, wherein the non-ionic surfactant is an alkyl ethoxylate.

7. A laundry detergent formulation as defined in claim 1, wherein the alkoxylated dye is of the form Dye-NR₁R₂, wherein the NR₁R₂ group is attached to an aromatic ring of the dye and R₁ and R₂ are independently selected from polyoxyalkylene chains having 2 or more repeating units.

8. A laundry detergent formulation as defined in claim 7, wherein the dye is an anthraquinone or an azo dye.

9. A laundry detergent formulation as defined in claim 8, wherein the alkoxylated dye is of the structure: 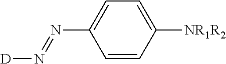
wherein D is aromatic or hetroaromatic group.

10. A laundry detergent formulation as defined in claim 9, wherein the dye is:

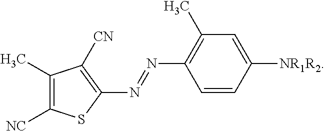

11. A laundry detergent formulation as defined in claim 1, wherein the laundry detergent formulation is granular.

12. A domestic method of treating a laundry textile, the method comprising the steps of:
(i) treating a textile with an aqueous solution of the 1 to 10 g/L of the formulation as defined in claim 1;
(ii) optionally rinsing; and,
(iii) drying the textile.
